(19) United States
(12) Patent Application Publication
(10) Pub. No.: US 2011/0320228 A1
(43) Pub. Date: Dec. 29, 2011

(54) Automated Generation of Markov Chains for Use in Information Technology

(75) Inventor: Vincent Joseph Kowalski, Houston, TX (US)

(73) Assignee: BMC SOFTWARE, INC., Houston, TX (US)

(21) Appl. No.: 12/872,933

(22) Filed: Aug. 31, 2010

Related U.S. Application Data
(60) Provisional application No. 61/358,239, filed on Jun. 24, 2010.

(51) Int. Cl. G06Q 10/00; G06F 15/18

(52) U.S. Cl. 705/7.11; 706/21

(57) ABSTRACT

Disclosed are methods and systems to automatically generate a model for pro-active rather than reactive enterprise systems management. In one embodiment, a Markov Chain model is constructed from a Configuration Management Database (CMDB), Service Impact models, event logs and system logs. The model can then be maintained and automatically updated or regenerated based on changing conditions and attributes of configuration items (CIs) being modeled. As part of model generations probabilities associated with potential state transitions of CIs can be calculated. The model can then be used to predict anticipated availability of a corporate enterprise or specific portions of a corporate information technology (IT) environment. In another embodiment, a model can be used to perform what-if scenarios to assist in planning or deferring change requests for the corporate IT environment.

### CROSS REFERENCE TO RELATED APPLICATIONS

This disclosure claims priority to Provisional U.S. Patent Application Ser. No. 61/358,239 filed 24 Jun. 2010 by Vincent Kowalski entitled “Method and System for Automated Generation of Markov Chains for use in Information Technology” and which is hereby incorporated by reference in its entirety.

### BACKGROUND

Today's enterprise computing environments comprise a plurality of servers, applications, services and business requirements (e.g., Service Level Agreements (SLAs) and Business Service Management (BSM)). A system administrator can have monitoring tools available to help him react to changing conditions within the enterprise. These tools typically monitor events and statuses to determine an effect a particular change in condition might have on a business requirement. Historically, these tools detect a change in condition and then propagate the impact of that change based on the infrastructure technology (IT) components experiencing the change.

Additionally, enterprises have consolidated information about their enterprise environment into a configuration management database (CMDB). The CMDB is designed and populated to store information to assist both the system administrator and the business administrator among others. The CMDB stores data about configuration items (CIs) in a “central location”. Information about CIs can be used to help track and satisfy performance metrics regarding SLAs and BSM. The CMDB can be a single database or can be federated to provide a centralized logical view from several separate data stores (e.g., distributed databases). Each discrete piece of information in a CMDB typically is associated with a Configuration Item (CI). CIs can represent a disk drive on a particular computer, the computer itself, a router, or even a business service. CIs can be either physical or logical in their nature. Also stored in a CMDB are relationships between particular CIs. Relationships can either represent dependency or impact between multiple CIs among other things. Note, dependency and impact are inverses of each other in a typical BSM management model. By way of example, a server is dependent on its disk drives, CPU, memory and network connectivity (among other things) while that same server is impacted if something is abnormal with anything it depends upon (i.e., disk failure would cause impact to server).

Clearly, the problems of systems management planning and analysis of relationships between CIs can be complex. The prior art has only addressed a re-active mode to systems management issues. Also, prior art techniques of capacity planning have been implemented only utilizing trend analysis of metric data as opposed to system management event data. Event data is different from metric data in that events typically reflect a change in status whereas metric data typically reflects a particular measurement. To address the above mentioned problems, a predictive or forecast approach to systems management may be desirable. Disclosed herein are embodiments to address, or at least reduce the impact of, these types of issues and others.

### SUMMARY

In one embodiment, a method of automatically generating a model of an enterprise infrastructure technology (IT) environment is disclosed. The method comprises receiving information regarding system management events and one or more associated configuration items (CIs) in an enterprise infrastructure technology (IT) environment; determining current and possible states for the one or more CI's, each of the one or more CI's representing a node in a model, the model representing at least a portion of the enterprise IT environment; determining possible state transitions associated with each of the one or more CI's, each state transition represented as an arc between nodes in the model; assigning a transition probability for each of the one or more determined state transitions; and predicting, based on the model, a change in an operational state of at least one of the one or more CI's. In this manner proactive rather than reactive systems management may be achieved. With information about probability of future state transitions, a system administrator may be enabled with information about how to prioritize or implement change management activities.

In another embodiment, a method of utilizing an automatically generated model of an enterprise infrastructure technology (IT) environment is disclosed. This method comprises determining change management operations to be performed in the enterprise IT environment based on probabilities of configuration item (CI) failure as indicated by an automatically generated model; and implementing at least a portion of the determined change management operations and updating the model to determine a next one or more change management operations to be performed. One of ordinary skill in the art will recognize, given the benefit of this disclosure, that without an automatic generation process of a model as disclosed herein, attempts to model a corporate IT enterprise or portion thereof will quickly become overly complex.

### BRIEF DESCRIPTION OF THE DRAWINGS

FIG. 1 illustrates, in block diagram form, an example of a subset of information stored in a configuration management database as well as other information that can be utilized to implement some of the disclosed embodiments.

FIG. 2 illustrates, diagrams representing a method of modeling probabilities associated with states and potential state changes between states (e.g., a Markov Chain or a Directed Graph).

FIG. 3 illustrates, in flowchart form, an embodiment of generating a graph model representing disclosed embodiments of how graph models may assists in proactive systems administration and business service management.

FIG. 4 illustrates, in block diagram form, an example computing device comprising a program control device.

### DETAILED DESCRIPTION

The present disclosure describes a method and system for constructing a model of an Information Technology (IT) environment in an automated manner. Having such a model of a system or service can be useful, for example, in analyzing enterprise system's components and their interdependencies with a view to improving their long-term up-time and reliability.

In general, there are several classes of information available from tools that may be deployed in an IT environment. At least three of these classes of information can be used to construct a model (e.g., event logs, system logs, and relationship information regarding particular CIs). In the context of this disclosure, a Markov chain is used as an example. However, many other types of probabilistic graph models may also be useful to implement all, or at least part of the modeling described herein. For example, Petri nets, directed graphs, or models of a stochastic finite state machine (FSM) may be used, either in whole or in part, to implement at least portions of the disclosed embodiments.

A Markov Chain is a form of Stochastic Finite State Machine. In a Markov Chain probabilities are assigned to each state transition and can be expressed as a matrix. A state transition is reflected in the model by the current state associated with a CI traversing an arch in the model. Each pass thorough a model can represent a set of scenarios with associated probabilities of state transition that can be calculated. Over some period of time probabilities tend to converge on a number which can be interpreted as the long-term probability of a given state.

To implement a Markov Chain to assist in IT management there are specific portions of information that may be obtained from information either readily available or ascertainable from a CMDB or other sources. Namely: 1) the possible states of the model and current states of individual CIs; 2) adjacencies of states to other states (gives structure to the Markov Chain); and 3) probabilities assigned to transitions between the states of the Markov Chain. Determination of the states and their adjacencies can typically be derived from information available in a Configuration Management Data Base (CMDB) relationship graph and possibly Service Impact Models, among other sources. Assignment of probabilities of state transitions can be made by using information available in system event logs and other event tracking mechanisms. It is also possible to only use event logs, however, in a preferred embodiment, relationships and impact models are also used. Once constructed, the Markov Chain can be adjusted in structure when new CIs are defined and thus become part of the model. Also, as more data becomes available the probability of state transitions may need to be updated based on the new information. For example, events or system log entries can be interpreted and used to alter probabilities associated with state transitions. Additionally, a probability of transition between states can be adjusted based simply on time passing as more samples of a current state are collected. For example, as time passes the probabilities associated with state transitions may change while the actual structure of the graph model will typically not be affected (if the only variable is time). Once constructed, a Markov Chain can be used to determine, for a given state, what the probability is for future states of CIs in a data center. Such a method and system could be useful in proactive datacenter management, problem anticipation, determination and remediation, system and application provisioning, capacity planning, etc. The disclosed systems and methods could also be valuable in root cause analysis, forensics and post mortem determination of system outages.

This disclosure also provides a facility for automatically generating and maintaining a Markov Chain representative of an IT environment. Systems and methods are disclosed to extract available information from an IT environment and build a Markov Chain automatically. Once built, the Markov Chain can be maintained and updated by subsequent monitoring of information available in the IT environment. As explained above, a main source of information to automatically generate a Markov Chain in accordance with this disclosure can be a CMDB. If available, a CMDB can have a large amount of information about an IT environment already defined and thus aid in the initial generation of a Markov Chain to represent the IT enterprise.

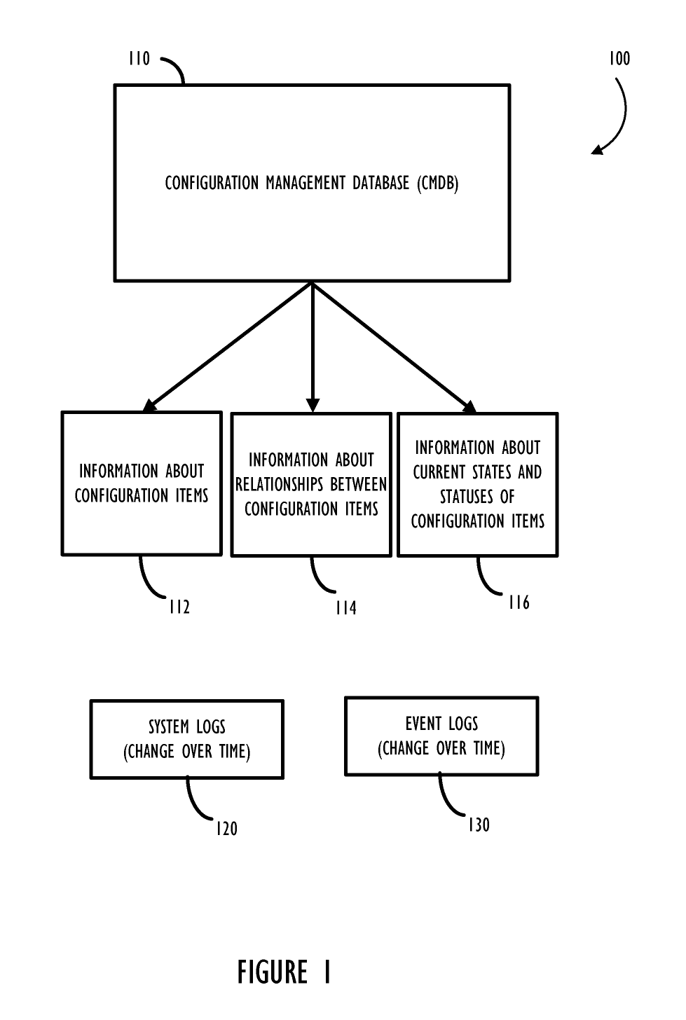

Referring now to FIG. 1, a block diagram 100 illustrates a subset of information available from a CMDB 110 and other systems management data sources. In the illustrated example, CMDB 110 contains information about Configuration Items (CIs) 112. The information about CIs 112 contained in a CMDB comprises attributes of particular CIs in an enterprise environment. For example, a CI can be defined to represent a disk drive on a computer system (not shown). For this example CI, CMDB 110 would typically contain information about attributes of the disk (e.g., total capacity, available capacity, in-service date, etc.). Also, information about relationships between CIs 114 can be stored in CMDB 110. Continuing with the disk example, relationships might include applications associated with data stored on the disk or users with permission to access the disk. If an application (defined as another CI in CMDB 110) depends on the availability of this particular disk to function at 100% then that information may also be available based on a relationship between the disk CI and the application CI within CMDB 110. Block 116 illustrates that CMDB 110 can also contain information about current states and statuses of CIs. As used herein, the current (or possible) state of a CI represents a node on the graph model currently (or potentially) associated with a given CI. In contrast, a status of a CI represents an operating condition of a CI. For example, the CI can have a status of: up/available, down/unavailable, or possibly some sort of warning condition (e.g., warn, critical, alarm, etc.).

Also shown in block diagram 100, block 120 illustrates the plurality of system logs available in a corporate enterprise and block 130 illustrates event notifications or event logs. Note, blocks 120 and 130 represent data that may be utilized in addition to data already available in CMDB 110. Alternatively, data available in system and event log sources may be monitored and processed such that interesting information is automatically populated within CMDB 110.

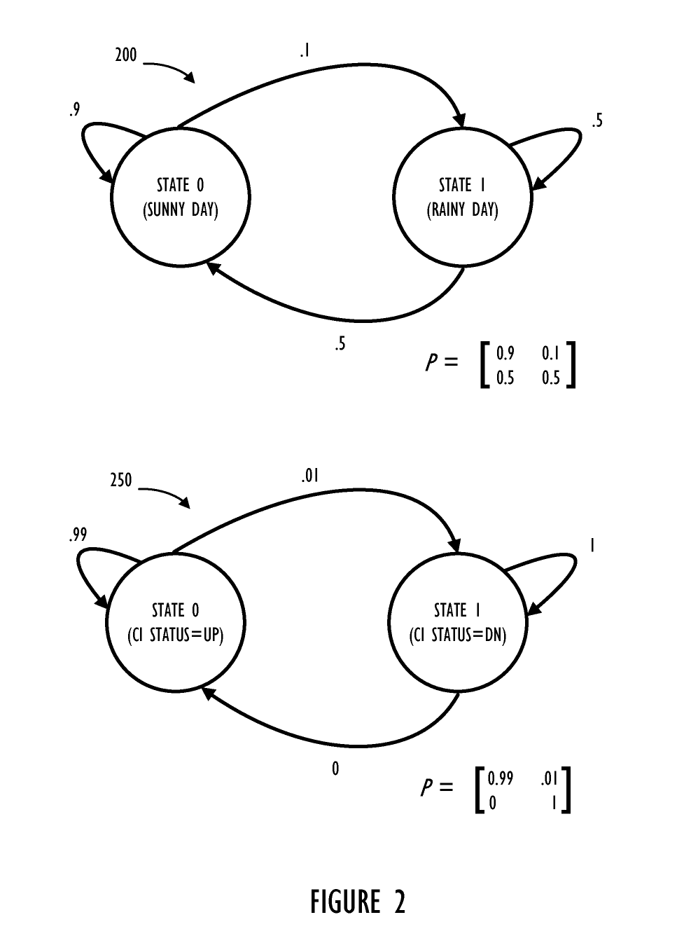

Referring now to FIG. 2, diagram 200 illustrates an easily understood example related to weather. Given that there could be rainy days (state 1) and sunny days (state 0) and probabilities determined empirically from historically recorded data, one can determine from the kind of weather on a given day the probability of the next day's weather. Example 200 illustrates that sunny days are followed by sunny days 90% of the time, rainy days follow sunny days 10% of the time, rainy days follow rainy days 50% of the time, and rainy days follow sunny days 50% of the time. As shown in diagram 200 the sum of probabilities exiting each state is equal to 100%.

To use this model in a practical way, assume we start out with a sunny day. The probability that the next day is a sunny day can now be determined and the probability that a second day will also be sunny can also be determined. Using a probability matrix, simple matrix multiplication can be used to determine a third day has a resulting probability of 86% sunny and 14% rainy. This can be repeated for any number of days to determine a long term probability. An interesting property of Markov Chains is that for this kind of data there is a steady state probability (i.e., what is the overall chance of a sunny or rainy day?). As one of ordinary skill in the art would understand, in this example the answer to that question is 83.33% sunny and 16.67% rainy.

Diagram 250 illustrates a Markov Chain model in the context of IT systems management. Having a Markov Chain model of an IT environment could be a powerful capability for analysis and prediction that currently is not available to System Managers and Administrators. Example diagram 250 illustrates a CI with 99% up time (state 0) and 1% down time (state 1). Note that state 1 has a 0% probability to transition out and is referred to as a “terminal state.” In the context of systems administration, this can imply that some action which will result in an update to the model or its probabilities must be performed prior to a status change of the CI. After the action is performed, transition probabilities can be recalculated and thus allow the CI to return to an up status (state 0).

In the context of change management within an enterprise system, having a model that can provide probabilities of certain outcomes given a current state, can allow administrators to pro-actively take action if certain undesirable future states have probabilities that rise above certain thresholds. As opposed to prior art techniques using only historical data in the form of metrics, state change probability calculations can provide a new way of addressing day to day systems management activities within an enterprise IT environment. In making changes to an operational environment, one of the biggest risks is that of unintended consequences. Adding more capacity to handle extra load or removing redundant components may seem like the right things to do in certain situations. But attempting to solve one problem in a complex IT environment can sometimes create other problems that may be difficult to anticipate. Having a Markov Chain model can enable Systems Architects and Analysts to simulate changes to a given IT environment and determine if such a change is benign or if it might have harmful side effects. For example, if the current state of a complex system that supports a mission critical service implies that there is a scenario where the service will become unavailable (the future state) with a probability greater than 1%, then action can be analyzed and taken to reduce that probability even before that scenario has the opportunity to play out.

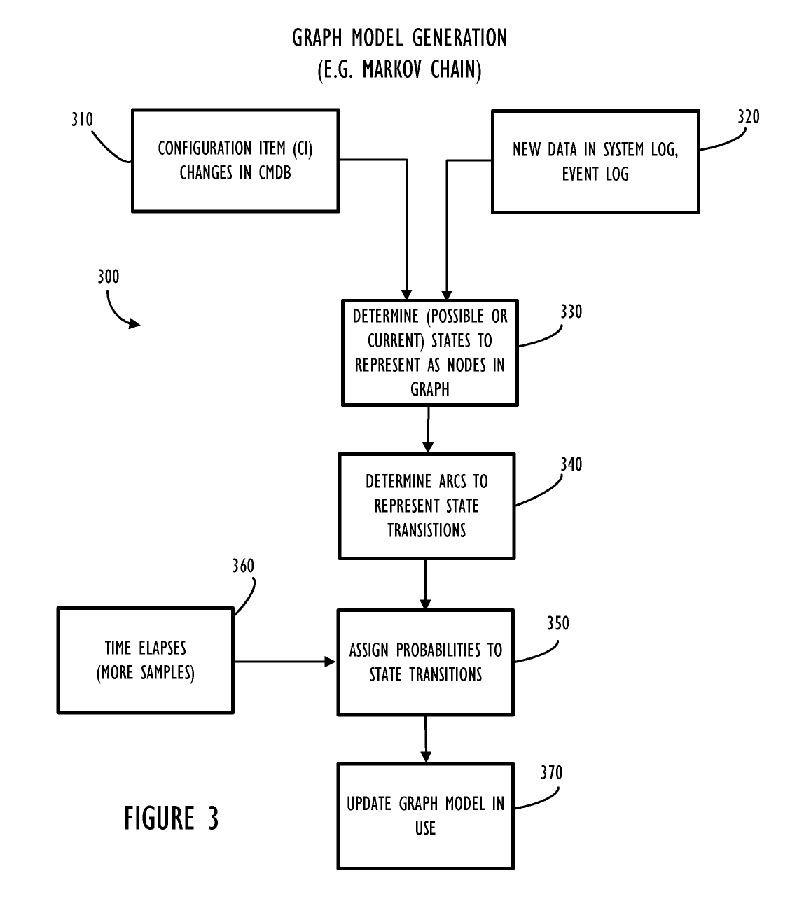

Referring now to FIG. 3, process 300 illustrates in flow chart form possible steps to automatically create and maintain a Markov Chain (or other probabilistic model) in the context of an IT enterprise environment. Input data for process 300 comprises information described in block diagram 100 as well as other potential sources of system configuration data. Beginning at block 310, a change to a CI may require an update to the current (or previously undefined) model. As stated above information about CIs can be maintained in a CMDB or other data sources. From the information available about CIs all possible or current states to represent as a node in the graph for a CI can be calculated at block 330. After all possible nodes are determined at block 330, state transitions, represented as arcs in a visual representation of the model, can be determined to give a topology to the nodes in the graph. After the structure of the graph is determined, flow continues to block 350 where probabilities associated with each arc (state transition) can be calculated. Finally at block 370, the updated model can be used to refresh or replace a model in use.

Also shown in process 300 are entry points 320 and 360. Beginning at block 320, information collected from system logs or event logs may indicate information requiring a change in the structure of the graph (Le., new node, a removal of a node and/or associated arcs). After this information is analyzed at block 330 flow can continue as described above. In the case where only more samples of data have been collected (block 360), it may be unlikely that a change in graph structure is required. Therefore, flow may be optimized by immediately assigning probabilities to state transitions at block 350. As will be recognized by those of ordinary skill in the art, opportunities for optimization of this process flow may be realized by analyzing input data (e.g., block 320) and determining that a structure change is not required such that processing input blocks such as 320 can bypass blocks 330 and 340.

Determining the states (Le., nodes) of a Markov Chain, shown as block 330, can be accomplished using at least three different methods, each of which can be used in isolation or in conjunction with other methods. The three methods of identifying States are: deduction from Event Logs, derivation from CMDB Relationship Graphs, and derivation from Service Models (either in Impact Manager or CMDB).

A Markov Chain can be constructed solely from the data available in an event log, assuming the event log has certain specific properties recorded about each event. To be useful in constructing a Markov Chain events in an event log should have the following properties: Unique ID, Event Type, Time Stamp (of when the event occurred), and the Object or CI with which that event is associated. Note, the requirement here is that an event model should have properties that semantically map to the properties listed above. There is no requirement on naming of these properties, their respective data types or units of measure used to record them. Additionally, there are some other properties that can be useful. These properties include, for example: Severity, Priority, Observer CI, Situation, Time Stamp (of when the event was observed or recorded). Furthermore, event correlation may be required to associate discrete events to determine a composite affect of two or more discrete events.

CMDB Relationship Graphs can provide clues as to what states should exist in a Markov Chain model. Certain classes of CI have properties from which states can be derived. For example, a class such as “Computer System” may have a property such as status. That status may have an enumeration of values such as: “Shutdown”, “Started”, “Running”, “Waiting” and so on. The combination of this status with its CI Class can be used to form distinct states in a Markov Chain model.

Service Models (sometimes referred to as Service Impact Models or Impact Models) can also provide clues as to what states should exist in a Markov Chain model. Certain CIs in the Service Model typically have properties from which states can be derived. For example, a service such as Email Service may have a property such as status. That status may have an enumeration of values such as: “OK” or “Warning”, “Critical”, and so on. The combination of this status with its service can be used to form distinct states in the Markov Chain model.

Determining adjacencies between states (i.e., arcs), shown as block 340, can be determined from CMDB Relationship Graphs. Certain classes of CI have relationships from which adjacent states can be derived. Also, CIs can transition from one discrete status to another discrete status during a given life cycle with each status being reflected by a different state (e.g., lifecycle transitions). As a simplified example, consider the classes “Application Software” and “Computer System.” Assume there is a “Hosted On” relationship between Application Software and Computer System. Also, assume that there is a status property for each of Application Software and Computer System, wherein the status property may have one of two values: Up or Down. Given this simplified scenario there are 4 states (one for each combination of CI and status) and the “Hosted On” relationship can be used to construct the transition arc or adjacency between states.

Service Models likewise can provide clues as to what adjacencies between states should exist in a Markov Chain model. Certain classes of CI have relationships from which states can be derived. Consider the classes “Business Service” and “Computer System.” Assume there is a “Depends On” relationship between Business Service and Computer System. Also, assume that there is a status property for each of Application Software and Computer System and that the status property may have one of two values: Up or Down. Given this simplified scenario we can construct 4 states for each combination of CI and status and use the “Depends On” relationship to construct the transition arc or adjacency between states.

One way to derive probabilities (block 350) is by performing statistical analysis on the information in the event logs. Statistical analysis can be done each time a new event is identified in an event log. An event log can be parsed at given time intervals and/or between each system startup/shutdown. For example, if event E₁ is followed by another event, E₂, a probability of 100% can be assigned. If on the next sample of data, E₁ is not followed by E₂ but instead event E₃ occurs, the probability that event E₁ is followed by event E₂ can be reduced by half to 50%. Note, E₁ and E₂ can be event types as opposed to individual events with unique IDs. By performing this analysis the assignment of the probabilities to the Markov Chain can be performed. This may be useful in scenarios where an IT environment does not have an Impact Manager or CMDB. Clearly, for initial iterations, the model may be in a greater state of flux and multiple samples may be required to provide for more accurate predictions. In one embodiment, advising a user as to when the model should be reliable could be implemented with a feature to measure “model turbulence” (i.e., how much the model changes with each training data set). Once the turbulence converges or is at least stable, the models can be used with some level of confidence. This approach can allow a user to dynamically train and adjust their model automatically every time there is new data.

In a preferred embodiment, states in a Markov Chain are created based on discrete time intervals rather than using events as they arise in sequential order and data interpolation can be performed for time samples when no new events have been detected. By keeping time as a variable it may be possible to properly implement probabilities when no new events have arrived or may be simply unavailable from the collected data. By using discrete time intervals as a variable (either expressly measured or inferred), a CI can be measured against other CIs that generate actual events. Consider a server generating no events (because no out of norm conditions have been detected on that server), a consistent discrete time sample period can be used to accurately reflect that the server has a high probability to remain available. For example, if 99 discrete time periods exist since this particular server has had an event and it was previously in a good state with an “UP” status it may be projected that the particular server has a 99% chance to be “UP” and in a good state at the next sample period. Recall, as described above, discrete time periods can be any arbitrary sampling period (e.g., once per second or even once per day/week/month).

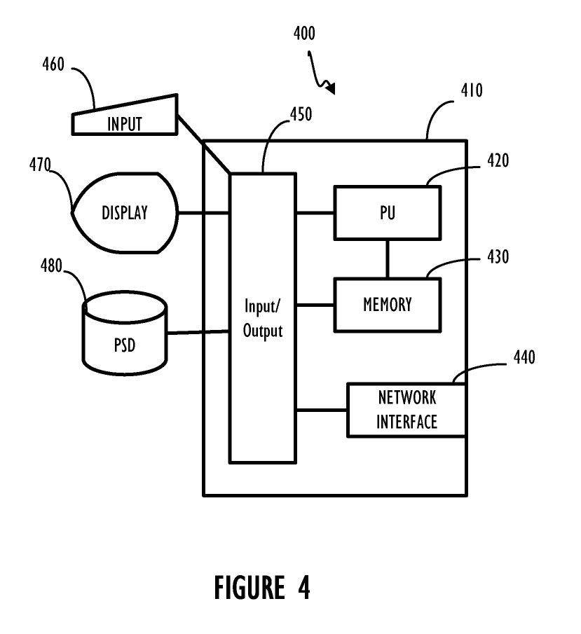

Referring now to FIG. 4, example computing device 400 is shown. One or more example computing devices 400 may be included in a mainframe computer (not shown). Example computing device 400 comprises a programmable control device 410 which may be optionally connected to input device 460 (e.g., keyboard, mouse, touch screen, etc.), display 470 or program storage device (PSD) 480 (sometimes referred to as a direct access storage device DASD). Also, included with program device 410 is network interface 440 for communication via a network with other computing and corporate infrastructure devices (not shown). Note network interface 440 may be included within programmable control device 410 or be external to programmable control device 410. In either case, programmable control device 410 will be communicatively coupled to network interface 440. Also note, program storage unit 480 represents any form of non-volatile storage including, but not limited to, all forms of optical and magnetic storage elements including solid-state storage.

Program control device 410 may be included in a computing device and be programmed to perform methods in accordance with this disclosure. Program control device 410 may itself comprise processor unit (PU) 420, input-output (I/O) interface 450 and memory 430. Processing unit 420 may include any programmable controller device including, for example, processors of an IBM mainframe (such as a quad-core z10 mainframe microprocessor). Alternatively, in non-mainframe systems examples of processing unit 420 include the Intel Core®, Pentium® and Celeron® processor families from Intel and the Cortex and ARM processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 430 may include one or more memory modules and comprise random access memory (RAM), read only memory (ROM), programmable read only memory (PROM), programmable read-write memory, and solid state memory. One of ordinary skill in the art will also recognize that PU 420 may also include some internal memory including, for example, cache memory.

Aspects of the embodiments are described as a method of control or manipulation of data, and may be implemented in one or a combination of hardware, firmware, and software. Embodiments may also be implemented as instructions stored on a machine-readable medium, which may be read and executed by at least one processor to perform the operations described herein. A machine-readable medium may include any mechanism for tangibly embodying information in a form readable by a machine (e.g., a computer). For example, a machine-readable medium (sometimes referred to as a program storage device or a computer readable medium) may include read-only memory (ROM), random-access memory (RAM), magnetic disc storage media, optical storage media, flash-memory devices, electrical, optical, and others.

In the above detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

Various changes in the details of the illustrated operational methods are possible without departing from the scope of the following claims. For instance, illustrative flow chart steps or process steps of FIG. 3 may be performed in an order different from that disclosed here. Alternatively, some embodiments may combine the activities described herein as being separate steps. Similarly, one or more of the described steps may be omitted, depending upon the specific operational environment the method is being implemented in. In addition, acts in accordance with FIG. 3 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices.

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method of automatically generating a model of an enterprise infrastructure technology (IT) environment, the method comprising:
receiving information regarding system management events and one or more associated configuration items (CIs) in an enterprise infrastructure technology (IT) environment;
determining current and possible states for the one or more CI's, each of the one or more CI's representing a node in a model, the model representing at least a portion of the enterprise IT environment;
determining possible state transitions associated with each of the one or more CI's, each state transition represented as an arc between nodes in the model;
assigning a transition probability for each of the one or more determined state transitions; and
predicting, based on the model, a change in an operational state of at least one of the one or more CI's.

2. The method of claim 1 wherein determining current and possible states comprises using information from one or more of a Configuration Management Database (CMDB), a Service Impact model, event log information, and system management log information.

3. The method of claim 1 wherein determining possible state transitions comprises using information from one or more of a Configuration Management Database (CMDB), a Service Impact model, event log information, and system management log information.

4. The method of claim 1 wherein associating a probability of transition comprises deriving a probability using statistical analysis of historical system management events.

5. The method of claim 4 further comprising, interpolating values for time samples in a time range when no events are available.

6. The method of claim 1 further comprising, deriving a model turbulence to determine when the model has stabilized to a desired level of stability prior to actual use in system management activities.

7. The method of claim 1 wherein receiving information regarding system management events and associated configuration items comprises receiving information from event monitoring tool logs.

8. The method of claim 1 wherein the model is used to perform what if scenarios on proposed change management activities.

9. The method of claim 1 wherein proposed change management activities are accelerated or deferred based on information derived from the model.

10. The method of claim 1 wherein a series of change management activities are prioritized based on information from the model.

11. The method of claim 1 wherein the model comprises one or more modeling techniques selected from the group consisting of directed graphs, Markov Chains, finite state machines, and Petri nets.

12. A method of utilizing an automatically generated model of an enterprise infrastructure technology (IT) environment, the method comprising:
determining change management operations to be performed in the enterprise IT environment based on probabilities of configuration item (CI) failure as indicated by an automatically generated model;
implementing at least a portion of the determined change management operations and automatically updating the model to determine a next one or more change management operations to be performed.

13. The method of claim 12 wherein the model comprises one or more modeling techniques selected from the group consisting of directed graphs, Markov Chains, finite state machines, and Petri nets.

14. The method of claim 12 wherein the model is automatically maintained solely from event log information.

15. The method of claim 12 wherein the model is maintained solely from a Configuration Management Database (CMDB).

16. The method of claim 12 wherein business service management or service level agreements are monitored and addressed based upon the model.

17. A computer readable medium comprising computer readable instructions stored thereon to cause a processing device to perform the method of claim 1.

18. A computer readable medium comprising computer readable instructions stored thereon to cause a processing device to perform the method of claim 12.

19. A computer network comprising:
a plurality of processing units communicatively coupled to a computer network;
a first processing unit configured to perform at least a portion of the method of claim 1 wherein the entire method of claim 1 is performed collectively by the plurality of processing units.

20. A computer network comprising:
a plurality of processing units communicatively coupled to a computer network;
a first processing unit configured to perform at least a portion of the method of claim 12 wherein the entire method of claim 12 is performed collectively by the plurality of processing units.

21. A computer system comprising one or more programmable control devices communicatively coupled to each other and to a computer network, wherein the one or more programmable control devices are programmed to perform the method of claim 1.

22. A computer system comprising one or more programmable control devices communicatively coupled to each other and to a computer network, wherein the one or more programmable control devices are programmed to perform the method of claim 12.
